(19) United States
(12) Patent Application Publication
(10) Pub. No.: US 2020/0147865 A1
(43) Pub. Date: May 14, 2020

(54) USE OF A DISPENSER ATTACHMENT FOR A DEVICE FOR WRITING 3D STRUCTURES BY MEANS OF LASER LITHOGRAPHY, AND DISPENSER ATTACHMENT

(71) Applicant: Nanoscribe GmbH, Eggenstein-Leopoldshafen (DE)

(72) Inventors: Joerg Hoffmann, Lustadt (DE); Thomas Sauter, Neckargemuend (DE); Christoph Linden, Ettlingen (DE); Christian Schach, Karlsruhe (DE)

(73) Assignee: Nanoscribe GmbH, Eggenstein-Leopoldshafen (DE)

(21) Appl. No.: 16/667,803

(22) Filed: Oct. 29, 2019

(30) Foreign Application Priority Data
Nov. 13, 2018 (DE) 10 2018 128 418.7

(51) Int. Cl. B29C 64/135; G02B 21/33; B33Y 10/00; B33Y 30/00; B29C 64/268; B29C 64/364; B29C 64/35; B33Y 40/00

(52) U.S. Cl. CPC B29C 64/135; G02B 21/33; B33Y 10/00; B33Y 40/00; B29C 64/268; B29C 64/364; B29C 64/35; B33Y 30/00

(57) ABSTRACT

A dispenser attachment for microscope objective lenses, in a device for writing three-dimensional structures by means of laser lithography in a lithographic fluid, which can be solidified by irradiation with laser light. The dispenser attachment may be adapted for being placed onto an objective lens.

The invention relates to the use of a dispenser attachment for objective lenses in the field of laser lithography. The invention also relates to dispenser attachments for objective lenses.

The technique referred to herein as laser lithography is also referred to as stereo lithography or direct laser typing, for example. In this technique, structures are written by means of a writing beam into a usually initially liquid, photosensitive substance, which is referred to herein as a lithographic fluid. In this case, a solidification effect is triggered locally in the lithographic fluid by the laser radiation of the writing beam. The solidification takes place, for example, due to local polymerization of the lithographic fluid induced by photon absorption. In the field of optical lithography, lithographic fluids are also referred to as photoresists.

The technique of laser lithography or of direct laser typing is advantageously used in the production of microstructures or nanostructures where high precision is desired and, at the same time, design freedom and flexibility in shaping are to be maintained. Unlike, for example, in mask lithography methods, various structures can namely be written without the structure being predetermined by a mask or the like.

In principle, it is known that the desired overall structure is generated by sequentially writing a series of substructures, which then complement one another to form the desired structure. Usually, the overall structures are written in layers or slices. For this purpose, in known techniques, the writing beam hits the surface of a volume of lithographic fluid and results in local solidification on the surface. In order to write three-dimensionally extended structures, in such methods, after writing a layer in one application step, an additional layer of lithographic fluid is applied. This can be achieved, for example, by gradually lowering a substrate together with the structure to be written thereon in a bath of lithographic fluid and structuring by means of the writing beam on the surface each time.

Another approach utilizes the physical principle of two-photon polymerization or, generally, multi-photon polymerization to achieve solidification of lithographic fluid even within a volume of lithographic fluid, i.e. below the surface.

This is made possible by the fact that the writing beam and lithographic fluid are coordinated with one another such that a solidification effect comes about with the aid of non-linear effects. For example, the writing beam is selected in a spectral range that normally cannot induce a solidification effect in the lithographic fluid. For example, the lithographic fluid and the writing beam can be coordinated with one another such that induced solidification could only take place by radiation having a wavelength which corresponds to a fraction (in particular an integral fraction) of the wavelength of the writing beam actually used. As a result, a solidification process is possible only with simultaneous absorption of two or more photons of the writing beam (two-photon polymerization or multi-photon polymerization). In the present context, the term “multi-photon polymerization” refers to the induced polymerization by the simultaneous absorption of two or more than two photons. In this respect, for the present description, the term “multi-photon absorption” also includes the process of “two-photon absorption.” The conditions required for multi-photon polymerization are usually only achieved in a zone of increased intensity. This zone of increased intensity is provided in a focus region of the writing beam. In this respect, the focus region is a beam waist of the writing beam that is generated by suitable optics (e.g. beam guiding optics, beam shaping optics and/or an objective lens). For the lithographic production of extended 3D structures, the focus region can then be moved in accordance with geometry writing data through a volume of lithographic fluid and can locally trigger a solidification process in each case.

A corresponding technique is described, for example, in DE 101 11 422 A1, which discloses 3D laser lithography utilizing multi-photon polymerization within a bath of lithographic material in a container. The apparatus described for this purpose comprises output optics for focusing the laser beam onto a focus region within the container.

From the field of microscopy, it is known to immerse an objective lens of a microscope together with its exit lens in an immersion oil. For this purpose, immersion oil dispensers are known in the manner of an attachment for microscope objective lenses. For example, US 2010/0027109 A1 and U.S. Pat. No. 3,837,731 B disclose immersion oil dispensers for being placed on a microscope objective lens. These dispensers comprise a housing which, when placed on an objective lens, defines a fluid chamber which opens into an output gap, which generally annularly surrounds the exit lens of the objective lens. Immersion oil is then provided in the fluid space and can exit through the output gap. Immersion in immersion oil takes place in the field of microscopy for the purpose of improving imaging quality and resolution.

In microstructuring or nanostructuring techniques, it is generally desirable to increase the throughput rate and to make the technique usable for producing large quantities. In particular, it is desirable to be able to quickly replace the substrate after writing a structure. For each individual structure, it should be possible to also be able to generate large structural depths and/or to be able to generate the structure over large areas in an extended manner. In order to generate extended structures, in said techniques, lithography fluid must be provided in a sufficiently large volume and, if necessary, replenished. This is not unproblematic since lithographic fluids may partially degrade over time or undergo undesirable changes, which may affect the quality of the structures generated.

The problem addressed is to release and, if necessary, replenish the lithography fluid in a suitable manner in laser lithography or direct laser typing.

This problem is solved by the use of a dispenser or a dispenser attachment according to the use steps according to claim 1.

The dispenser attachment is used in a device for writing three-dimensional structures by means of laser lithography in a lithographic fluid. A device of this type comprises a laser beam source for emitting a writing beam and usually a substrate on which a volume of lithographic fluid can be absorbed and provided. The lithographic fluid can locally solidify by means of the writing beam to generate a structure. The device also comprises various optical components, for example a beam-guiding and forming apparatus and an objective lens for guiding the writing beam and for forming a focus region of the writing beam in the lithographic fluid. In the present context, the objective lens is of particular importance. The objective lens comprises an objective-lens housing having an exit lens through which the writing beam emerges from the objective lens. In the present context, the term “exit lens” generally refers to the optical element that forms the transition from the objective lens into the environment. The exit lens may be a lens means in the proper sense (e.g. converging lens). However, the exit lens does not necessarily have to have an optical lens effect, but rather can also be designed as an exit window, for example.

The dispenser attachment used comprises an in particular cap-like dispenser housing, which is designed to be placed on the objective lens or on the objective-lens housing. In this case, the dispenser housing is designed such that, when placed, a fluid space is formed between the objective-lens housing and the dispenser housing. The fluid space opens into an output gap which is formed between the dispenser housing and exit lens of the objective lens. Fluid can escape from the fluid space through the output gap into a space in front of the exit lens. In particular, the dispenser housing has an opening in the region of the exit lens such that an annular gap is formed between an opening edge and the exit lens. The dispenser attachment also comprises a fluid access into the fluid space for supplying fluids into the fluid space such that fluid can continuously escape through the output gap.

Various steps are carried out for the claimed use. First, a lithographic fluid is provided which is coordinated with the laser beam source such that the solidification can take place only in the focus region and only by utilizing a two-photon process or, more generally, a multi-photon process. The lithographic fluid is then supplied into the fluid space through the fluid access. The use then comprises the step of applying a volume of lithographic fluid through the output gap. In this case, the application is to be understood to be dispensing lithographic fluid through the output gap into an outer space. In particular, the volume of lithographic fluid is applied to the substrate or to an existing volume of lithographic fluid. Finally, the writing beam, or more specifically the focus region of the writing beam, is introduced through the objective lens into the volume of lithographic fluid. This results in local solidification of the lithographic fluid in the focus region by means of a two-photon process or, more generally, a multi-photon process (involvement of two or more photons simultaneously). In this way, a three-dimensional structure can be written within the lithographic fluid.

Owing to this manner of using a dispenser attachment, the laser lithography device is extended and improved such that structures can be continuously generated. In particular, it is possible to generate high structures and/or structures having large profile depths relative to the direction of introduction of the writing beam. This can be carried out by moving the objective lens or a print head of the lithographic device comprising the objective lens away from the substrate surface and continuously replenishing lithographic fluid through the output gap.

The described use e.g. offers the advantage that, after writing a structure on a substrate, it can be removed and a new substrate can be provided. In particular, it is not necessary to apply a layer or volume of lithographic fluid to the substrate prior to writing a structure. In this respect, pretreatment steps can be reduced and simplified. As a result, a production process having a high throughput rate is made possible by the laser lithography devices of the type mentioned.

In the procedure described, the lithographic fluid can be stored in a separate reservoir, which is connected to the fluid space by a fluid line. Optionally, a fluid pump may be provided, which pumps the fluid from the reservoir into the fluid space. As a result, exposure of the lithographic fluid to the ambient atmosphere is largely avoided. This can reduce contamination of the lithographic fluid and undesirable degradation of the lithographic fluid. This favors the quality of the written structures.

In the claimed use, it is in particular possible to also use microscope objective lenses, as they are available as standard components for microscopes. In particular, a dispenser attachment can then be used, as used in the field of microscopy for the application of immersion oil with the aim of improving optical properties. In this respect, the invention relates to the use of a dispenser of the type mentioned for the purpose of applying lithographic fluid.

According to a fundamental aspect, the focus region is positioned in particular in the region between a surface of the substrate and the exit lens of the objective lens.

According to an advantageous embodiment, the step of applying lithographic fluid is carried out such that the lithographic fluid remains in contact with the exit lens and the writing beam is introduced into the lithographic fluid while it is still in contact with the exit lens. In this respect, the focus region is introduced into a volume of lithographic fluid which is in contact with the exit lens. Since the local solidification of the lithographic fluid in the focus region takes place only by utilizing a two-photon process or, more generally, a multi-photon process, the solidification takes place in the focus region spaced apart from the exit lens and not directly in the region of the lithographic fluid volume, which adheres to the exit lens. This prevents the exit lens from adhering due to solidified lithographic fluid. Since the lithographic fluid adheres directly to the exit lens, an optical interface in the beam path between the exit lens and focus region is avoided (as would occur e.g. in a transition between air and lithographic fluid or lens and air). As a result, aberrations can be reduced, which can lead to quality losses and inaccuracies in the written structure. The described procedure makes the lithographic fluid available in situ. The steps of applying and writing the structure can be carried out in succession without interruption. In order to write extended structures, a drop of lithographic fluid may, for example, first be applied, then structures may be written into the drops, and then the lithographic fluid is replenished to provide more space for further structure portions.

It may be advantageous if the applying step is carried out such that the lithographic fluid remains in contact both with the substrate and with the exit lens and the writing beam is introduced into the lithographic fluid while the lithographic fluid is in contact with the exit lens and the substrate. In this respect, the lithographic fluid in particular fills the space between the exit lens and the substrate. In this respect, a cohesive droplet is formed between the exit lens and the substrate, which stabilizes the fluid volume and the structures written therein. Here too, continuous writing of large structures is made possible by moving the objective lens continuously away from the substrate and continuously replenishing lithographic fluid. In particular, it is possible to prevent the droplet of lithographic fluid from being pulled off the objective lens.

An advantageous development of the use consists in that a first lithographic fluid is provided and applied through the fluid space and the output gap, and then, optionally with further steps being interposed, a second lithographic fluid is provided and applied through the fluid space and the output gap. In this case, it is in particular conceivable that the first lithographic fluid and the second lithographic fluid are different materials in particular having different material properties. In particular, after applying the first lithographic fluid and before applying the second lithographic fluid, a first structure may first be written in the lithographic fluid by the writing beam. Thereafter, the second lithographic fluid can be applied and a second substructure can be written. In this respect, multi-material structures can be produced in this procedure.

However, it may also be advantageous for the two different lithographic fluids to be applied in succession and mixed together. The writing beam is then preferably introduced into a volume of mixed first lithographic fluid and second lithographic fluid. The procedure described thus makes it possible to adapt material properties in a targeted manner, for example by different mixing ratios. The two lithographic fluids can be mixed in various ways, for example by an intrinsic diffusion process or using mixing aids (for example a compressed air jet).

In a further embodiment, after the step of introducing the writing beam and in particular the focus region and after the local solidification of the lithographic fluid, a developer fluid is provided and the developer fluid is supplied through the fluid access into the fluid space. The developer fluid is in particular designed to expose and/or cure the written three-dimensional structure. For example, the developer fluid may be a solvent that is coordinated with the lithographic fluid such that only unsolidified lithographic fluid is dissolved and solidified lithographic fluid remains. By applying a volume of the developer fluid through the output gap, the written structures can be exposed in situ.

The described procedure can be further developed by supplying a compressed gas into the fluid space. In particular, a step can then be provided in which the compressed gas exits through the output gap. This step may be provided at different times, for example before the first application of lithographic fluid. In this case, for example, contamination can be removed from the substrate. However, it is also conceivable for the compressed gas to escape through the output gap after the application of a volume of lithographic fluid in order to distribute or displace the lithographic fluid on the substrate. It is also conceivable, after applying two different lithographic fluids (see above), to mix the two lithographic fluids by means of escaping compressed gas. Compressed air or an inert gas can be used as compressed gas, for example.

In a further embodiment, a cleaning fluid can be provided and supplied to the fluid space, and optionally ejected through the output gap. The cleaning fluid is in particular designed such that both unsolidified (liquid) and solidified lithographic fluid is dissolved. The cleaning fluid is ejected through the output gap is in particular such that the exit lens is wetted with the cleaning fluid. By means of this procedure, in situ cleaning is made possible, in particular in the sense of an automated cleaning procedure. This is preferably carried out after writing a structure and/or before changing substrates. This shortens process times because the cleaning procedures can be simplified and shortened.

The fluid space can be used to generate additional functionalities. For example, light can be introduced into the fluid space, for example by means of an optical waveguide that opens into the fluid space. Depending on the configuration, the light then exits through the output gap and can be used to illuminate the substrate and/or an already applied volume of lithographic fluid and/or an already written three-dimensional structure. This is advantageous because, in the direct laser typing process, in situ image monitoring of the written structure is usually desirable. It is furthermore conceivable that an image of the illuminated structure and/or of the substrate is also recorded by means of the objective lens used for writing. Light may be introduced, for example, after the lithographic fluid is supplied through the fluid access into the fluid space. In this case, the lithographic fluid can contribute to the light guidance from the fluid space through the output gap. Light can, for example, penetrate into the fluid space through the fluid access or through a separate access.

An immersion lens can in principle be used as an objective lens. Such immersion lenses are known, for example, as accessories in microscopy and serve to achieve improved imaging quality in this field. In particular, an immersion lens is used which has a configuration which is adapted to the refractive index of the lithographic fluid used.

The problem stated at the outset is also solved by dispenser attachments which are particularly advantageous for the use described above. In particular, for solving the problem, systems composed of an objective lens and a dispenser attachment adapted thereto are also used.

An advantageous dispenser attachment or an advantageous system composed of a dispenser attachment and an objective lens comprises an in particular cap-like housing which is designed to be placed onto the objective lens or the objective-lens housing such that a fluid space is formed and an output gap is formed between the dispenser housing and the exit lens of the objective lens. Furthermore, a dispenser attachment has a fluid access for supplying fluids into the fluid space. A particularly suitable dispenser attachment results from the fact that the dispenser housing is adapted to the objective lens such that the output gap is an annular gap around the exit lens, the annular gap being delimited by a peripheral edge of the dispenser housing such that the exit lens projects beyond the dispenser housing. In particular, the exit lens projects beyond the dispenser housing in the beam direction of the writing beam. As a result, when used according to the above description, structures which have already been written are prevented from abutting the dispenser housing during the movement of the objective lens and from being damaged thereby.

A dispenser attachment which is particularly suitable for the described use or a particularly suitable system composed of a dispenser attachment and an objective lens is also obtained in that the dispenser housing has an inner wall and an outer wall surrounding the inner wall, such that the inner wall faces the objective-lens housing and in that the fluid space is formed between the inner wall and the outer wall. Preferably, the inner wall has a transmission window that is made of a fluid-tight and optically transparent material and faces the exit lens. In particular, the transmission window of the exit lens is positioned so as to be opposite in the beam direction. The output gap is preferably formed between the exit window and the outer wall. In this respect, such a dispenser attachment comprises a double-walled dispenser housing and the fluid is guided between the inner wall and outer wall. By means of the transmission window, the exit lens is prevented from coming into direct contact with the lithographic fluid. The inner wall also prevents the objective-lens housing and/or optical components of the objective lens from coming into contact with the lithographic fluid. This prevents contamination. In addition, said embodiment allows the use of standard air objective lenses. The inner wall and outer wall are preferably formed as substantially circular cylindrical walls. Preferably, the outer wall coaxially surrounds the inner wall. The beam path through the objective lens and dispenser attachment is preferably concentric through these walls.

An advantageously usable dispenser attachment or system composed of a dispenser attachment and an objective lens also results from the fact that the dispenser housing has at least one additional access into the fluid space. The additional access is in particular formed separately from the fluid access. Additional functions can be introduced into the fluid space through this access. For example, access for the supply of fluids (e.g. pressurized fluid or different lithographic fluids) or for the supply of light into the fluid space may be provided. In this case, the access may comprise an optical waveguide, by means of which light from a preferably external light source can be introduced into the fluid space.

The invention will be explained in greater detail in the following with reference to the drawings, in which:

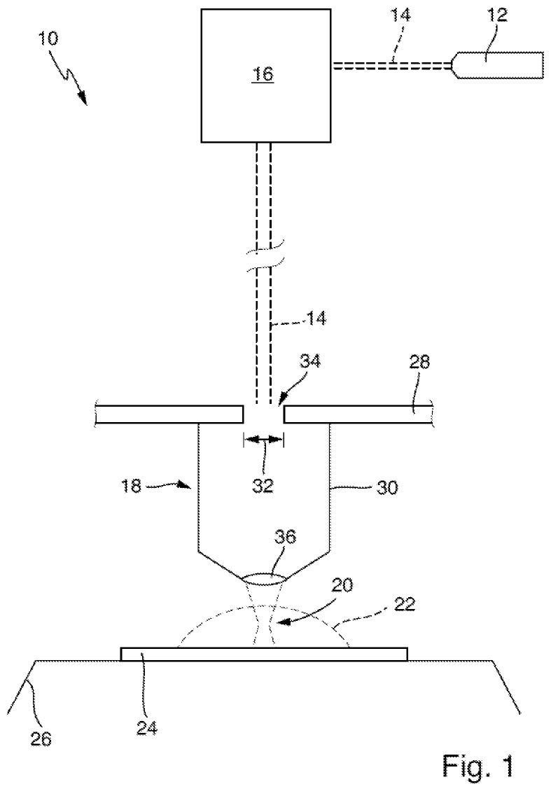

FIG. 1 is a schematic view of a device for writing structures by means of laser lithography in a lithographic fluid;

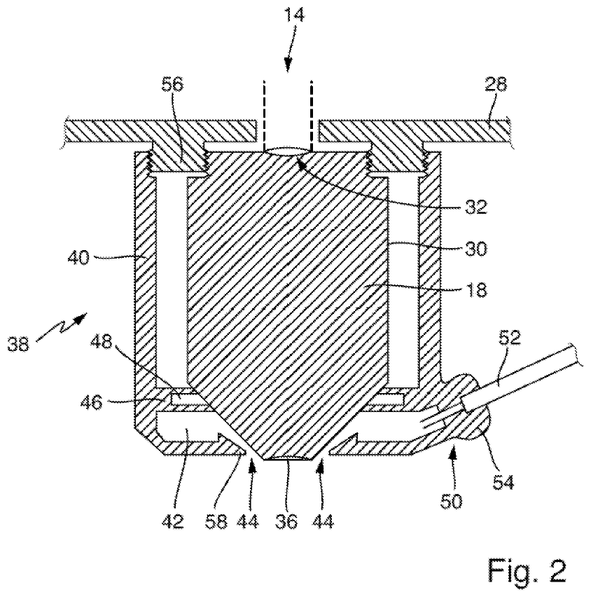

FIG. 2 is an outline of a dispenser attachment for use in a device according to FIG. 1;

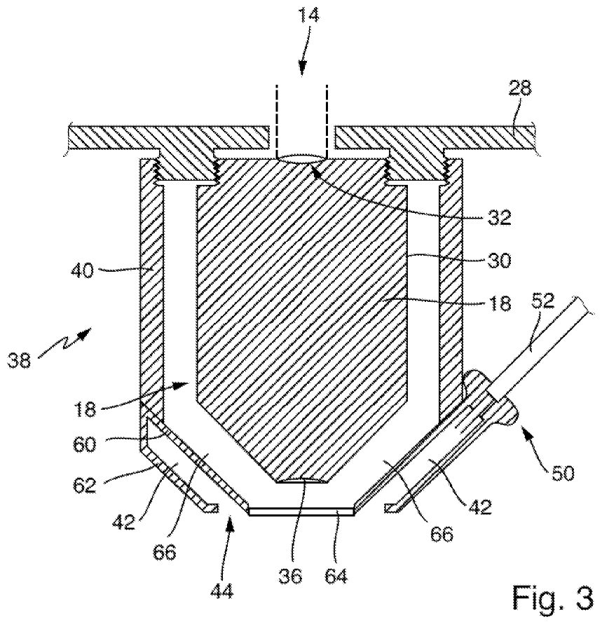

FIG. 3 is an outline explaining further possible embodiments of a dispenser attachment for use in a device according to FIG. 1; and

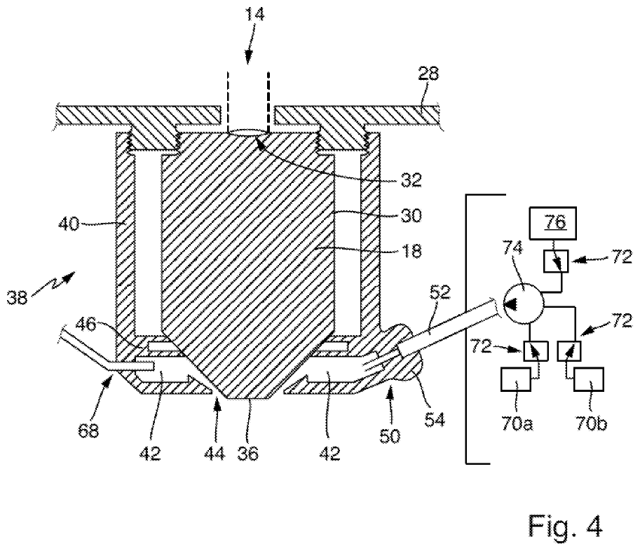

FIG. 4 is an outline explaining further possible embodiments for a dispenser attachment for use in a device according to FIG. 1.

In the following description and in the drawings, the same reference signs are used in each case for identical or corresponding features.

FIG. 1 is an outline of a device 10 for writing three-dimensional structures by means of laser lithography in a lithographic fluid, referred to as a laser lithography device 10 for short. The device 10 comprises a laser beam source 12 for emitting a writing beam 14 of laser light. Depending on the embodiment, the writing beam 14 passes through a beam-guiding and forming apparatus 16, which forms a writing beam suitable for the purpose of laser lithography from the light emitted by the laser beam source 12 and, for example, deflects or moves the writing beam according to geometry writing data for a desired structure. For this purpose, the beam-guiding and forming apparatus 16 can interact with a control apparatus (not shown).

The writing beam 14 is converted into an output beam having a focus region 20 by means of an objective lens 18. The focus region 20 is formed in particular in the manner of a beam waist of the writing beam 14.

For writing a three-dimensional structure, the focus region 20 is introduced into a volume of lithographic fluid 22 and, if necessary, moved in the volume according to the geometry writing data for the desired structure. In the focus region 20, the writing beam 14 initiates a solidification reaction in the lithographic fluid 22. So that the solidification reaction can also take place within the volume of the lithographic fluid 22, i.e. below a surface of the lithographic fluid 22, for the purposes of the present invention, the lithographic fluid 22 is coordinated with the writing beam 14 such that the solidification takes place only in the focus region 20 and only by utilizing multi-photon absorption processes.

In the example shown, the volume of lithographic fluid 22 is applied to a substrate 24 in droplets. However, this is not mandatory. The volume of lithographic fluid 22 may also be provided in a container or, as discussed below, may be provided in the manner of a droplet that is in contact with the objective lens 18. The substrate 24 may be attached to a substrate holder 26, which is for example designed to be movable in a writing plane.

The objective lens 18 may, for example, be mounted on a top plate 28 of the device 10. It is conceivable that the top plate 28 is also designed to be slightly movable using corresponding actuators.

Overall, the construction of the device 12 allows the focus region 20 to be moved in three spatial directions within the volume of lithographic fluid 22.

The objective lens 18 comprises an objective-lens housing 30, which is preferably mounted on the top plate 28 such that an entry aperture 32 of the objective lens 18 corresponds to a corresponding opening 34 in the top plate 28. The writing beam 14 is irradiated in a beam direction through the opening 34 and the entry aperture 32. The objective lens 18 also comprises an exit lens 36 through which the writing beam 14 exits and forms the focus region 20.

The use of a dispenser attachment 38 in a device in the manner of FIG. 1 will be explained by way of example with reference to FIGS. 2 to 4. These figures each show an example of a detail of a device 10 of the type shown in FIG. 1 as a view of a detail in the region of the top plate 28 and of the objective lens 18.

FIG. 2 shows a dispenser attachment 38 comprising a dispenser housing 40, which can be placed on the objective lens 18 such that the dispenser housing 40 surrounds the objective lens 18 at least in regions. As a result, a fluid space 42 is delimited by the dispenser housing 40 or by the dispenser housing together with wall regions of the objective-lens housing 30. The dispenser housing 40 has a downward (i.e. facing away from the top plate 28) opening such that an output gap 44 is formed together with the objective lens 18. The output gap 44 is preferably designed such that it in particular annularly surrounds the exit lens 36. Preferably, the output gap 44 directly adjoins an edge of the exit lens 36. In this respect, the fluid space 42 opens into the environment through the output gap 44.

Preferably, the volume of the fluid space 42 in the interior of the dispenser housing 40 is delimited and sealed in that a sealing projection 46 of walls of the dispenser housing 40 points radially inwards such that, when the dispenser housing 40 is placed on the objective lens 18, the sealing projection 46 abuts the objective-lens housing 30 and thereby seals the fluid space 42. A corresponding annular seal 48 may be arranged in the sealing projection 46, for example, in order to improve the fluid-tightness.

The dispenser attachment 38 also comprises a fluid access 50 for supplying fluid into the fluid space 42. For this purpose, for example, a fluid line 52 can pass through a corresponding sealing portion 54 on the dispenser housing 40 and can open into the fluid space 42.

The objective lens 18 and the dispenser attachment 38 preferably form a coordinated system. In particular, the objective lens 18 and the dispenser attachment 38 are mounted on a print head of the device 10 using coordinated mounting means. As outlined in FIG. 2, the top plate 28 may, for example, comprise a double-threaded ring 56, the objective-lens housing 30 being screwed to an internal thread of the double-threaded ring 56, and the dispenser housing 40 being screwed to the opposite external thread of the double-threaded ring 56.

According to an advantageous aspect, the objective lens 18 and the dispenser attachment 38 are coordinated with one another such that the exit lens 36 of the objective lens 18 projects beyond the dispenser housing 40 in the region of a peripheral edge 58 in the direction of propagation of the writing beam 14 (cf. FIG. 2).

The dispenser attachment together with the objective lens 18 is then used in the device 10 by first providing a lithographic fluid 22 and supplying said fluid to the fluid space 42 through the fluid access 50. According to a general aspect, it may be provided that the lithographic fluid is supplied through the fluid access 50 at a corresponding pressure, such that the lithographic fluid is distributed as uniformly as possible in the fluid space 42 and is pushed out of the fluid space 42 in the direction of the output gap 44. This allows a volume of lithographic fluid to be applied to the substrate 24 through the output gap 44, for example in the manner of a droplet (cf. FIG. 1). It is also conceivable for a volume of lithographic fluid 22 to adhere to the exit lens 36 of the objective lens 18 after the lithographic fluid 22 has exited through the output gap 44. It may also be advantageous, if enough lithographic fluid 22 is applied, for it to fill a space between the exit lens 36 and the substrate 24. In this respect, in a suitable embodiment of the objective lens 18, the exit lens 38 can be immersed in the applied volume of lithographic fluid 22 (in the manner of an immersion lens).

Thereafter, by generating the writing beam having the focus region 20 in the manner explained with reference to FIG. 1, the desired structure can be written. If desired, further lithographic fluid 22 may then be replenished, namely by supplying lithographic fluid 22 through the fluid access 50 into the fluid space 42 and through the output gap 44.

Another advantageous use of a dispenser attachment 38 is possible with the embodiment shown in FIG. 3. According to said embodiment, the dispenser attachment 38 may be double-walled and in this respect may have an inner wall 60 and an outer wall 62 extending concentrically therewith. As a result, the fluid space 42 is formed between the inner wall 60 and the outer wall 62. Preferably, both the inner wall 60 and the outer wall 62 extend coaxially around the objective-lens housing 30, for example in the manner of circular cylindrical lateral surfaces.

In a further embodiment, the inner wall 60 facing the objective lens 18 may have a transmission window 64, which faces the exit lens 36 in the assembled state of the dispenser attachment 38, such that the writing beam 14 emerging through the exit lens 36 exits through the transmission window 64. In particular, the inner wall 60 and the transmission window 64 are formed such that a closed air space 66 is formed around the objective-lens housing 30 and the exit lens 36, which is separated from the fluid space 42 by the inner wall 60 and/or the transmission window 64.

Using this dispenser cap 38, lithographic fluid 22 is supplied through the fluid access 50 into the fluid space 42 and does not come into contact with the exit lens 36 of the objective lens 18. Preferably, the output gap 44 is then formed between the transmission window 64 and the outer wall 62 of the dispenser attachment 38.

The use of the dispenser attachment 38 allows various additional functions (see FIG. 4). For this purpose, the dispenser housing 40 may be designed such that an additional access 68 is provided in the fluid space 42. It is possible, for example, to guide an optical waveguide (not shown in greater detail) through the additional access 68, by means of which optical waveguide light can be introduced into the fluid space 42, for example to illuminate the space in front of the exit lens 36. It is also conceivable that compressed gas or other fluids are introduced into the fluid space 42 through the additional access 68, as described above.

An advantageous use of the dispenser attachment 38 results from the fact that different lithographic fluids, which in particular have different material properties, are successively supplied into the fluid space 42 through the fluid access 50 (cf. FIG. 4). For this purpose, different lithographic fluids 22 can be provided in separate fluid reservoirs 70a, 70b. Optionally, fluid from the reservoir 70a or 70b can then be conveyed through the fluid line 52 into the fluid space 42 via corresponding switching valves 72 (for example, by means of a fluid pump 74). In another embodiment, it is also conceivable that a developer fluid or a cleaning fluid, which can in turn optionally be supplied to the fluid space 42 via a switching valve 72 and if necessary via a fluid pump 74, is provided in at least one additional reservoir 76.

The dispenser attachments outlined in FIGS. 2 to 4 are essentially used in accordance with the use steps described at the outset.

1-15. (canceled)

16. A Use of a dispenser attachment for microscope objective lenses, in a device for writing three-dimensional structures by means of laser lithography in a lithographic fluid, which can be solidified by irradiation with laser light, the device including at least the following: a laser beam source for emitting a writing beam, a substrate for receiving lithographic fluid, an objective lens for forming a focus region of the writing beam in the lithographic fluid, the objective lens including at least an objective-lens housing and an exit lens, and wherein the dispenser attachment including at least a dispenser housing which is designed to be placed onto the objective lens such that a fluid space is formed between the objective-lens housing and dispenser housing and that an output gap is formed between the dispenser housing and the exit lens, and a fluid access into the fluid space, wherein said Use of the dispenser attachment comprising:
providing a lithographic fluid which is coordinated with the laser beam source such that the solidification takes place only in the focus region and by utilizing a multi-photon process;
supplying the lithographic fluid into the fluid space through the fluid access;
applying a volume of lithographic fluid through the output gap; and
introducing the writing beam into the volume of lithographic fluid through the objective lens and causing local solidification of the lithographic fluid in the focus region by means of a multi-photon process for writing the three-dimensional structure.

17. The Use according to claim 16, wherein
the applying step is carried out such that the lithographic fluid remains in contact with the exit lens and the writing beam is introduced into the lithographic fluid while the lithographic fluid is in contact with the exit lens.

18. The Use according to claim 16, wherein
the applying step is carried out such that the lithographic fluid remains in contact both with the substrate and with the exit lens.

19. The Use according to claim 16, wherein
a first lithographic fluid is provided, is supplied into the fluid space through the fluid access and a first volume of the first lithographic fluid is applied through the output gap, and
after that a second lithographic fluid is provided, is supplied into the fluid space through the fluid access and a second volume of the second lithographic fluid is applied through the output gap.

20. The Use according to claim 19, wherein
the first lithographic fluid and the second lithographic fluid are different materials having different material properties.

21. The Use according to claim 19, wherein
after applying the first lithographic fluid and before applying the second lithographic fluid, at least one step of introducing the writing beam into the volume of first lithographic fluid and locally solidifying the first lithographic fluid is carried out.

22. The Use according to claim 19, wherein
the first lithographic fluid is first applied and then the second lithographic fluid is applied, and then the first lithographic fluid and the second lithographic fluid are mixed.

23. The Use according to claim 16, wherein
after the step of introducing the writing beam and locally solidifying the lithographic fluid, the following steps are carried out:
providing a developer fluid for exposing and/or curing the written three-dimensional structure;
supplying the developer fluid into the fluid space through the fluid access; and
applying a volume of developer fluid through the output gap.

24. The Use according to claim 16, comprising at least the following additional step:
providing and supplying pressurized gas into the fluid space through the fluid access or through an additional access to the fluid space.

25. The Use according to claim 16, comprising at least the following additional step:
providing cleaning fluid designed to dissolve non-solidified and solidified lithographic fluid;
supplying the cleaning fluid into the fluid space through the fluid access or through an additional access to the fluid space; and
ejecting cleaning fluid through the output gap.

26. The Use according to claim 16, comprising at least the following additional step:
introducing light into the fluid space.

27. The Use according to claim 16, wherein
an immersion lens is used as the objective lens.

28. The Dispenser attachment adapted for mounting on an objective lens, which comprises an objective-lens housing and an exit lens designed for the use according to claim 16, the dispenser attachment comprising at least the following:
a dispenser housing which is designed to be placed onto the objective lens such that a fluid space is formed between the objective-lens housing and dispenser housing and that an output gap is formed between the dispenser housing and the exit lens, and
a fluid access into the fluid space, wherein
the dispenser housing is designed such that the output gap is an annular gap around the exit lens, the annular gap being delimited by a peripheral edge of the dispenser housing such that the exit lens projects beyond the dispenser housing.

29. The Dispenser attachment adapted for mounting on an objective lens, which comprises an objective-lens housing and an exit lens designed for the use according to claim 16, the dispenser attachment comprising at least the following:
a dispenser housing which is designed to be placed onto the objective lens such that a fluid space is formed between the objective-lens housing and dispenser housing and that an output gap is formed between the dispenser housing and the exit lens of the objective lens,
a fluid access into the fluid space, wherein
the dispenser housing has an inner wall and an outer wall surrounding the inner wall, such that the inner wall faces the objective-lens housing, and in that the fluid space is formed between the inner wall and the outer wall, and in that the inner wall has a transmission window that is made of a fluid-tight and optically transparent material and faces the exit lens, the output gap being formed between the transmission window and the outer wall.

30. The Dispenser attachment adapted for mounting on an objective lens, which comprises an objective-lens housing and an exit lens designed for the use according to claim 16, the dispenser attachment comprising at least the following:
a dispenser housing which is designed to be placed onto the objective lens such that a fluid space is formed between the objective-lens housing and dispenser housing and that an output gap is formed between the dispenser housing and the exit lens of the objective lens,
a fluid access into the fluid space, wherein
the dispenser housing comprises at least one additional access into the fluid space, the additional access being designed for supplying fluids or light into the fluid space.

31. The Use according to claim 16, comprising at least the following additional step:
introducing light into the fluid space, by means of an optical waveguide, which opens into the fluid space.

32. A Process for and/or Method of Using a dispenser attachment for microscope objective lenses, in a device for writing three-dimensional structures by means of laser lithography in a lithographic fluid, which can be solidified by irradiation with laser light, the device including at least the following:
a laser beam source for emitting a writing beam, a substrate for receiving lithographic fluid, an objective lens for forming a focus region of the writing beam in the lithographic fluid, the objective lens including at least an objective-lens housing and an exit lens, and wherein the dispenser attachment including at least a dispenser housing which is designed to be placed onto the objective lens such that a fluid space is formed between the objective-lens housing and dispenser housing and that an output gap is formed between the dispenser housing and the exit lens, and a fluid access into the fluid space, wherein said Process for and/or Method of Using the dispenser attachment comprising:
providing a lithographic fluid which is coordinated with the laser beam source such that the solidification takes place only in the focus region and by utilizing a multi-photon process;
supplying the lithographic fluid into the fluid space through the fluid access;
applying a volume of lithographic fluid through the output gap; and
introducing the writing beam into the volume of lithographic fluid through the objective lens and causing local solidification of the lithographic fluid in the focus region by means of a multi-photon process for writing the three-dimensional structure.
